(19) United States
(12) Patent Application Publication
(10) Pub. No.: US 2026/0100844 A1
(43) Pub. Date: Apr. 9, 2026

(54) BLOCKCHAIN BASED READ RECEIPT

(71) Applicant: nChain Licensing AG, Zug (CH)

(72) Inventors: Liuxuan PAN, London (GB); Adina WINEMAN, London (GB)

(21) Appl. No.: 19/115,136

(22) PCT Filed: Sep. 4, 2023
(86) PCT No.: PCT/EP2023/074135

§ 371 Date: Mar. 25, 2025

(30) Foreign Application Priority Data
Sep. 29, 2022 (GB) 2214283.0

(51) Int. Cl. H04L 9/32; H04L 9/00; H04L 9/08

(52) U.S. Cl. CPC H04L 9/3236; H04L 9/0825; H04L 9/0861; H04L 9/3247; H04L 9/50

(57) ABSTRACT

A computer-implemented method of requesting a read receipt for a message using a blockchain, the read receipt evidencing that the message has been opened, the method being performed by a first party and comprising: sending the message, and/or an encrypted version thereof, to a second party; generating a cryptographic puzzle based on the message; generating a request blockchain transaction, wherein the request blockchain transaction comprises a first output locked by a first locking script, wherein the first locking script is configured to, when executed together with a first unlocking script of a response blockchain transaction, require the first unlocking script to comprise a solution to the cryptographic puzzle; and determining that the message has been opened in response to determining that the first output has been unlocked.

### CROSS REFERENCE TO RELATED APPLICATIONS

This application is the U.S. National Stage of International Application No. PCT/EP2023/074135 filed on Sep. 4, 2023, which claims the benefit of United Kingdom Patent Application No. 2214283.0, filed on Sep. 29, 2022, the contents of which are all incorporated herein by reference in their entireties.

### TECHNICAL FIELD

The present disclosure relates to methods of requesting and sending read receipts using a blockchain.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

### SUMMARY

A “read receipt” refers to an acknowledgment that a message has been received. Read receipts have been integrated into several messaging systems, such as email, text messaging, and social messaging applications. However, existing read receipts only provide evidence that a message has been received, and not necessarily that the message has been read. For instance, the recipient of an email may simply send a read receipt upon receipt of the email, without actually opening the email and viewing its contents. In addition, so far no existing read receipts have incorporated the feature of the read receipt being immutable, which means that it is possible for a party to allege that a read receipt they have previously sent is inaccurate, or that the message content has changed since they sent the read receipt.

One example scenario in which it is necessary to prove a message has been received is in the process of serving notice of legal proceedings. Legally, many jurisdictions require a party commencing legal proceedings against a second party to provide the second party with notice of the proceedings. However, it is known for some parties to ignore letters and other such attempts to make contact, and then to allege that they have not received notice when the legal proceedings begin. It is advantageous to know whether a second party have acknowledged receipt, or alternatively if they are ignoring attempts at contact, in which case alternative methods of message delivery may be used.

According to one aspect disclosed herein, there is provided a computer-implemented method of requesting a read receipt for a message using a blockchain, the read receipt evidencing that the message has been opened, the method being performed by a first party and comprising: sending the message, and/or an encrypted version thereof, to a second party; generating a cryptographic puzzle based on the message; generating a request blockchain transaction, wherein the request blockchain transaction comprises a first output locked by a first locking script, wherein the first locking script is configured to, when executed together with a first unlocking script of a response blockchain transaction, require the first unlocking script to comprise a solution to the cryptographic puzzle; and determining that the message has been opened in response to determining that the first output has been unlocked.

According to another aspect disclosed herein, there is provided a computer-implemented method of sending a read receipt for a message using a blockchain, the read receipt evidencing that the message has been opened, the method being performed by a second party and comprising: receiving a message, and/or an encrypted version thereof; identifying a request blockchain transaction, wherein the request blockchain transaction comprises a first output locked by a first locking script, wherein the first locking script is configured to, when executed together with a first unlocking script of a response blockchain transaction, require the first unlocking script to comprise a solution to the cryptographic puzzle; generating a response blockchain transaction, wherein the response blockchain transaction comprises a first input that references the first output of the request transaction, the first input comprising a solution to the cryptographic puzzle, wherein the solution is based on the message.

Advantageously, this provides both parties with tamper-proof evidence that the second party received the message, without revealing any information about the message on chain. Additionally, it provides both parties with evidence that the message has been read.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 is a schematic block diagram of a system for implementing a blockchain-based read receipt between two individuals,

FIG. 4 is a sequence flow diagram illustrating steps that may be used to implement a blockchain-based read receipt between two individuals,

FIG. 5A is an example messaging service user interface used to generate a read receipt,

FIG. 5B is an example illustration of a read receipt generated by a messaging service,

FIG. 6 is a flowchart illustrating example steps for implementing a blockchain-based read receipt between two individuals, and

FIG. 7 is a schematic diagram illustrating the process of generating a blockchain-based read receipt between two individuals.

### DETAILED DESCRIPTION OF EMBODIMENTS

### 1. Example System Overview

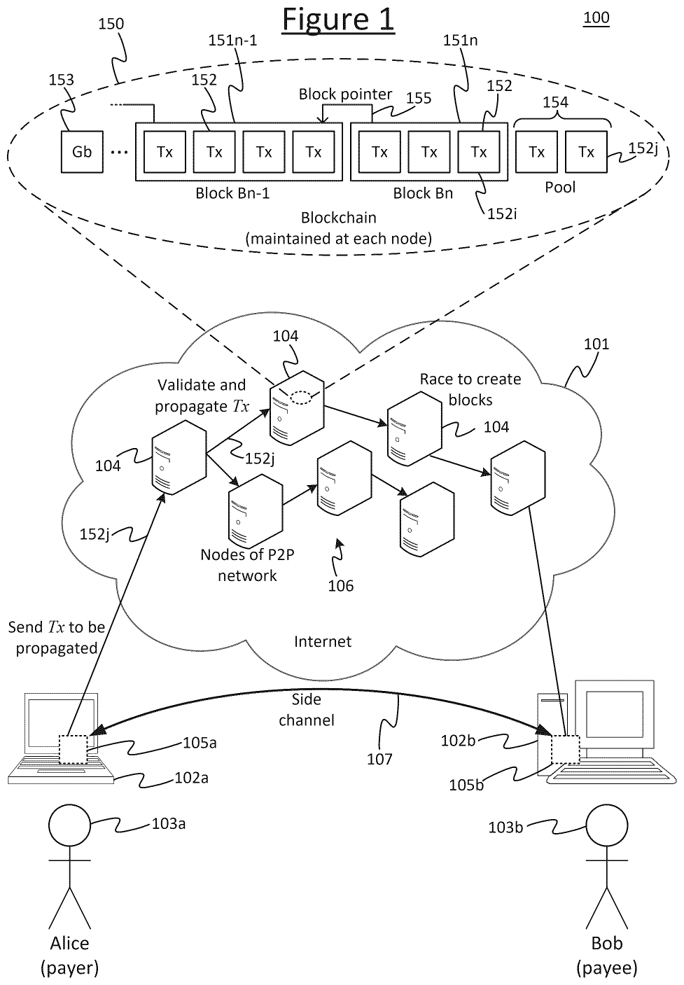

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction spends (or “assigns”), wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (or “spent”) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n−1 in the chain. The significant amount of effort, for example in the form of hash, required to create a proof-of-work solution signals the intent of the first node 104 to follow the rules of the blockchain protocol. Such rules include not accepting a transaction as valid if it spends or assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152.

Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### 2. UTXO-Based Model

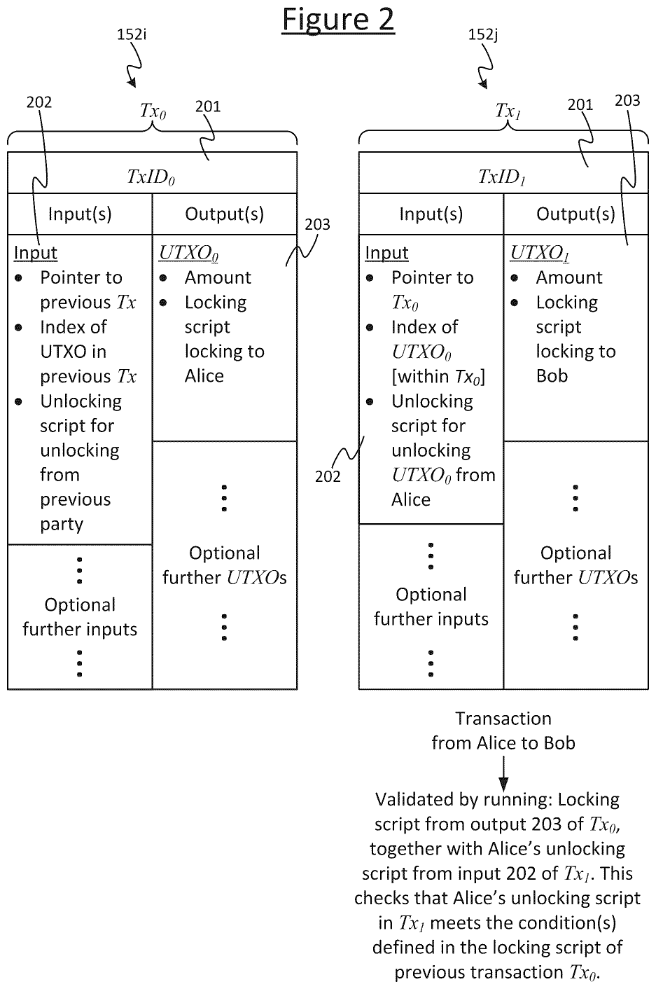

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:

<Sig P_{A}><P_{A}>∥[Checksig P_{A}]

where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx valid. This means that the blockchain node 104 will add Tx to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned (or spent) by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 3. Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### 4. Non-Blockchain Read Receipt

This section briefly describes an example of an existing read receipt mechanism. Taking Outlook as an example, a sender can request a read receipt for a message via two methods:
Method 1: File->Options->Mail->Tracking->Read receipt confirming the recipient viewed the message for all messages sent.
Method 2: a new email->Options->ticking ‘request a read receipt’ for a single message sent. Note that if using this method, the receipt response can't be tracked until a read receipt is received.

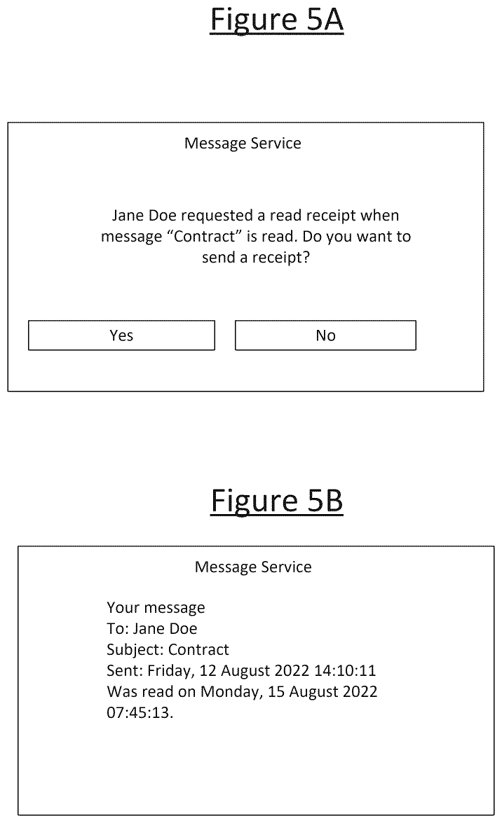

When the recipient opens the message, a popup will appear as shown in FIG. 5A.

Message recipients decide whether to send a read receipt. If choosing yes, then a read receipt will be sent to the message sender. An example from the Outlook is shown in FIG. 5B.

This read receipt is sent via an email that shows the timestamp and other relevant metadata. For message senders, the status of the sent message shifts from “Delivered” to “Read” because it has been opened.

### 5. Cryptographic Techniques

### 5.1 Elliptic Curve Digital Signature Algorithm (ECDSA)

The ECDSA scheme is used to create and verify digital signatures using elliptic curves. This section briefly describe the processes of generating a digital signature and verifying it based on the ECDSA scheme. Digital signatures are used to prove the ownership of the UTXOs.

### 5.1.1 Signature Generation

To generate a signature, a private key V is required to prove the identity. A corresponding public key PK is calculated by:

$$P K = V \cdot G ,$$

where ‘·’ denotes elliptic curve scalar multiplication, G is the elliptic curve generator point.

Now, given the private key V, one can generate a signature on a message m using the ECDSA scheme in the following way:
1. Double hash the message m using the SHA-256 hash function:

$$e = SHA - 256 ( SHA - 256 ( m ) ) .$$

2. Randomly choose an integer k∈{1, 2, . . . , n−1} as an ephemeral private key.
3. Calculate the corresponding ephemeral public key R=k·G=(x, y).
4. Take the x-coordinate of the calculated point R:

$$r = {[ R ]}_{x} ,$$

where [R]ₓ denotes the process of taking the x coordinate of an elliptic curve point. Note that if r=0, the signature will be independent from V, so return to step 2 and choose another k.
5. Calculate the modular inverse k⁻¹ of k mod n, where n is some prime modulus.
6. Calculate s=k⁻¹ (e+Vr) mod n. If s=0, return to step 2 and choose another k·s≠0 is to ensure that signature verification is possible, as its inverse is required.
7. The signature is then given by (r, s).

It is worth noting the same message m can have different signatures since k is an ephemeral key and different for each case.

### 5.1.2 Signature Verification

Given the message m, the public key PK and the signature (r, s), we could verify the signature using the following calculating:

$${R}^{′} = SHA - 256 ( SHA - 256 ( m ) ) {s}^{- 1} \cdot G + r {s}^{- 1} \cdot PK .$$

If [R′]ₓ=r, then the signature is valid, otherwise it is invalid.

### 5.1.3. R-Puzzle

An R-Puzzle is a type of script that allows the spending party to sign the input UTXO using any valid elliptic curve keypair. In an R-puzzle, one should prove the knowledge of k that is used to allow the input UTXO to be spent. k is the ephemeral private key in the ECDSA signature. For the sake of security, k is not revealed in the R-puzzle, instead r= [k·G]ₓ is revealed onto the blockchain when solving the puzzle. Note that, k could be any knowledge that needs to be proven in the R-puzzle.

### 5.1.4. Pay to R-Puzzle Hash (P2RPH)

A P2RPH transaction is a transaction that pays to a R-puzzle challenge. To spend the input UTXO, one needs to provide an unlocking script with a signature that contains the same r used for the R-puzzle challenge.

The ScriptPubKey and ScriptSig for a P2RPH transaction is shown below:

scriptPubKey: OP_DUP OP_3 OP_SPLIT OP_NIP OP_1 OP_SPLIT
OP_SWAP OP_SPLIT OP_DROP
OP_HASH160 H(r) OP_EQUALVERIFY OP_OVER
OP_CHECKSIGVERIFY OP_CHECKSIG
scriptSig: <sig′> <PK> <sigᵣ>

The signature sigᵣ is generated over r and the spender can calculate the signature using any private/public keypair. The signature sig′ signs a different message than the one signed by Sigᵣ, which could be done by using a different sighash flag. Note that the signature sig′ must use a different ephemeral key so that it does not leak the private key.

The signature sig′ is added to the scriptSig to avoid the signature forgeability. Without the signature sig′, a malicious actor could intercept the P2RPH transaction and then change the transaction to send the funds to himself while using the same signature that the transaction sender used in the original transaction.

5.1.5. Script with Conditional Clauses

Conditional clauses can be implemented in blockchain script using the OP_IF statements. OP_IF executes the set of subsequent opcodes up to the following OP_ELSE or OP_ENDIF if the value on top of the stack is true, or non-zero. If an OP_ELSE is the subsequent conditional clause and the first conditional clause was successful, the script will jump forward to the OP_ENDIF at the conditional-stack height of the original clause. Once the OP_ENDIF is processed, then the script execution will end and return the result.

### 5.1.6. Identity Based Encryption Schemes

Identity Based Encryption (IBE) is a type of public key encryption scheme where a public key of a user can be an arbitrary string such as an email address or a username. The associated private key can only be generated by a trusted third party named Private Key Generator (PKG). Users submit their identities (e.g., email addresses) to the PKG and obtain private keys related to the identities. In the IBE scheme, the sender encrypts the message using the recipient's identity (e.g., email address) and some public parameters assigned by the PKG. The recipient can then decrypt the message with the private key obtained from the PKG.

### 6. Blockchain-Based Read Receipt

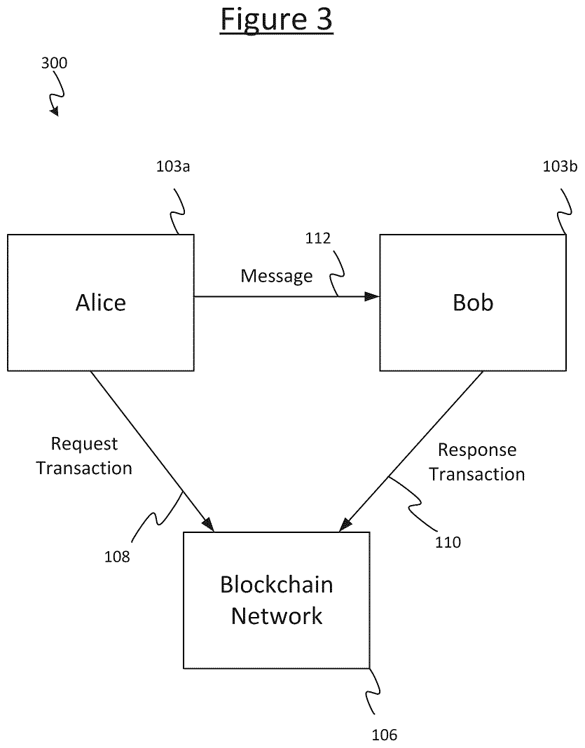

FIG. 3 shows an example system 300 for issuing and responding to read receipts using a blockchain 150. In general the read receipt may be for any type of message, such as an email, text message, chat bot message, social media message, etc. As shown, the example system 300 includes a first party (e.g. Alice 103a), a second party (e.g. Bob 103b), and a blockchain network 106. The first party and the second party will herein be referred to as Alice 103a and Bob 103b respectively. Alice 103a and Bob 103b are both able to communicate with each other, as shown by the arrow 112, and are also able to send information to and read information from the blockchain 150, e.g. via one or more blockchain nodes 104, as shown in FIG. 1. To generate a blockchain-based read receipt for a message, Alice generates a request transaction 108 that includes, as part of an output, a cryptographic puzzle based on the message. Alice then sends the request transaction 108 to the blockchain network 106, either directly or indirectly. Alice also sends the message to Bob. Bob constructs a response transaction 110, which spends the output of the request transaction 108, demonstrating that he has knowledge of the message. That is, Bob's response transaction 110 includes, as part of an input that references the output of the request transaction 108, a solution to the cryptographic puzzle, where the solution is based on the message. Alice then checks for the existence of the response transaction 110 on the blockchain 150 to determine that a message has been received correctly by Bob. Alice may actively check the blockchain 150 for the response transaction 110, or she may be alerted to the response transaction 110 by Bob and/or the blockchain network 106.

The read receipt provides evidence that the message has been received correctly and opened by Bob. In embodiments, the read receipt may also provide evidence that the message has been read.

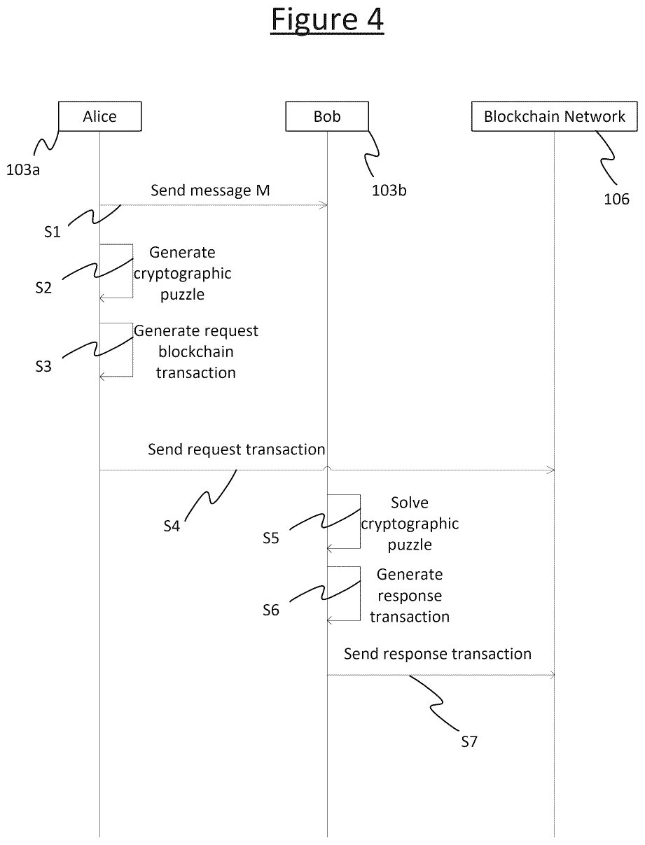

FIG. 4 shows a sequence flow diagram illustrating an example set of steps Alice and Bob may take to generate a read receipt. It will be appreciated that some steps may be performed in a different order.

At step S1, Alice 103a sends a message M to Bob 103b. This message may be in encrypted form. For example, the message may be sent using asymmetric or symmetric encryption. As an example, Alice may encrypt the message using an IBE scheme based on Bob's identifier, such as his email address. Alternatively, the message may be sent in non-encrypted form. The message may comprise any type of data. For example, the message may be a text-based message. Alternatively, the message may be an audio or video recording. The latter may be used when wishing to prove content of an oral disclosure.

Alice also generates a cryptographic puzzle at step S2. This cryptographic puzzle may require a solution to comprise a signature using an ephemeral private key, wherein the ephemeral private key may only be determined by the recipient of the message. For example, the cryptographic puzzle may utilise the R-puzzle technique described above. Alternatively or additionally, the cryptographic puzzle may require a solution to comprise the preimage of a hash contained in the cryptographic puzzle. For example, the cryptographic puzzle may utilise the hash puzzle technique described above. The cryptographic puzzle may also require the solution to comprise a signature using one or more additional private keys.

At step S3, Alice generates a request blockchain transaction 108, which herein refers to the transaction via which she requests a read receipt for the message. She includes the cryptographic puzzle in the locking script for a first output of the transaction. Note that “first” here is being used merely as a label for a particular output, and does not necessarily mean the output that appears logically first in the transaction. She may optionally include other outputs in the transaction. For example, she may also include an output paying funds to Bob's public key. This may cause Bob's wallet to detect the transaction, which may alert him to the request. Alternatively or additionally, Alice may send a transaction identifier (TxID) of the request transaction to Bob over a message channel to alert Bob to the request. She may also include further outputs requesting read receipts from other parties. Each output containing a read receipt may be generated in a similar way.

The request blockchain transaction may take as input any number of UTXOs. For example, the request transaction may take as input an output of a previous request blockchain transaction. In this case, Alice's request transaction requesting a read receipt from Bob could also function as her read receipt to Bob for a previous message.

The first output may lock only a dust (i.e. minimum) quantity of funds. In this case, the first output has no significant monetary value to either Alice or Bob. Alternatively, the first output may lock a larger quantity of funds. For example, Alice's message may detail a contract between her and Bob, and Bob's read receipt may signal his consent to the terms.

At step S4, Alice then sends the request blockchain transaction to the blockchain network 106.

Bob receives the message, and obtains the request blockchain transaction, e.g. either using a notification from his wallet, or the TxID he has received from Alice. Bob then uses the message to solve the cryptographic puzzle, as shown at step S5. Bob generates a response blockchain transaction, in which he unlocks the first output of the request transaction using his solution to the cryptographic puzzle at step S6. At step S7, he sends the response blockchain transaction to the blockchain network 106. He may then send the funds to his account, or use them as payment for a further service. For example, he may use the funds to create a new read receipt request.

Bob may create a further output sending funds to Alice. Alternatively or additionally, Bob may send the first output back to Alice. Alternatively or additionally, Bob may notify Alice of the TxID of his response blockchain transaction.

Alice then determines, on the basis of the response blockchain transaction, that Bob has received and acknowledged the message. Bob may demonstrate by showing the presence of the response blockchain transaction on the blockchain that he received and acknowledged the message. At a later date, Alice or Bob may prove the message they agreed upon by locating the request and/or response blockchain transactions, and demonstrating that the solution to the cryptographic puzzle was based on the message. If either party alters the message, then the new message will not be the basis for a solution of the cryptographic puzzle, so tampering will be evident.

Note that, in this context, a read receipt does not necessarily prove that Bob has read and processed the message. A read receipt shows that a message has been received and opened. This is generally not a problem, as read receipts are generally used for a sender to know that a recipient has received information. If the recipient chooses not to read the information, then they disadvantage themselves only. For example, if Alice sends Bob an agreement and Bob sends a read receipt but doesn't actually read the message, then he disadvantages himself by agreeing to the agreement without checking. Alice knows from the read receipt that Bob was given the opportunity to read the message.

In some examples, however, the read receipt may prove that Bob has read the message. For example, the cryptographic puzzle may be based on only a portion of the message, so Bob may need to read the message to retrieve the correct portion. In other examples, the cryptographic puzzle may be based on the whole message, but the message server may ensure that Bob reads the message by other means. For example, the response blockchain transaction may not be generated until Bob has scrolled through the message in its entirety.

In some examples, the cryptographic puzzle employs a method referred to herein as the “Pay to Public Key Hash method”. In this method, Alice generates a first hash based on the message. She also generates a first private key, and a first value based on the first hash and the first private key. The first hash may be a hash of the entire message, or a hash of a portion of the message. Alternatively, the first hash may be a hash generated by concatenating the message, or a portion thereof, with a pseudorandom number. Such hashes are generally referred to as “salted hashes”, and the pseudorandom number in such a hash is referred to as a “salt”. In general the hash may be generated using any suitable hash function, such as the SHA256 algorithm or RIPEMD-160 algorithm. Further hash algorithms are known to the skilled person. The hash may be computed by running the algorithm once, or alternatively the hash algorithm may be run more than once. For example, the SHA256 algorithm may be applied twice to a hash or salted hash of the message. Alternatively or additionally, several hash algorithms may be used in sequence. For example, a first iteration may use SHA256, then a second iteration may use the RIPEMD-160 hash function, taking the resultant hash from the SHA256 algorithm as input, to generate a final hash to be used as the first hash based on the message.

In some embodiments, the first value may be generated by adding together the first hash and the private key. In some embodiments, the first value may be generated by adding together the first hash, the first private key, and a further value. In other embodiments, the first value may be generated by subtraction of the hash from the private key, or subtraction of the hash and first private key from a further value. Further alternatives will be apparent to the skilled reader. The first value is then included in the transaction. In some embodiments, the first value may be included in the transaction as an OP_RETURN value.

In some examples, the cryptographic puzzle employs a method in which the hash is used to generate a private key, herein referred to as the “R-Puzzle Hash method”. In this method, Alice generates a first hash based on the message, then uses this first hash to generate a first private key. As discussed above, the first hash may be based on all or part of the message, may be salted, may be generated by any known hash algorithm, and may be generated by applying one or more hash algorithms in sequence.

The first private key may be the first hash, or may be generated based on the first hash. For example, the private key may be generated by padding the first hash or by stripping the first hash of some number of end bits.

In some examples, the cryptographic puzzle is generated using a method requiring a recipient to show knowledge of a hash preimage, herein referred to as the “Hash Reveal method”. In this method, Alice first generates a first hash based on the message, which may be based on all or part of the message, may be salted, may be generated by any known hash algorithm, and may be generated by applying one or more hash algorithms in sequence, as discussed in greater detail above. Alice then generates a second hash by hashing the first hash. The first hash is therefore the preimage of the second hash. The cryptographic puzzle comprises the second hash, and a solution of the cryptographic puzzle must comprise the preimage of the second hash, which is the first hash.

The cryptographic puzzle, generated using any of the above methods, may further comprise a condition that requires a signature generated using a second (different) private key. For example, the second private key may be Bob's private key. The solution to the cryptographic puzzle therefore indicates that Bob, and not another individual, received and acknowledged the message. Alternatively or additionally, the cryptographic puzzle may be configured to require a signature using a sum of the first private key and a second private key. The first locking script comprising the cryptographic puzzle may then be configured to carry out point addition of the second public key and a first public key based on the first private key, in order to check that a signature provided in the first unlocking script is generated using the first and second private keys in combination. The locking script may be configured to use the techniques disclosed in any of Patent Application No. 2200991.4, Patent Application No. 2200992.2, and Patent Application No. 2200993.0 to carry out point addition. Other suitable techniques may be used instead.

The first locking script incorporating the cryptographic puzzle, generated using any of the above methods, may further incorporate a first conditional clause sub-script, wherein the first conditional clause sub-script is configured to allow unlocking of the output when an unlocking script contains a signature using a third private key. For example, this may be Alice's private key. This means that, if Bob refuses to acknowledge the message by sending a response transaction, Alice may reclaim the funds locked in the first output. Advantageously, the first conditional clause sub-script may be incorporated alongside the feature of requiring a signature using a second private key, to ensure that Alice can reclaim the funds even without knowledge of the second private key.

The first locking script may alternatively or additionally incorporate a second conditional clause sub-script. The second conditional clause sub-script may comprise two alternative options for Bob to choose in satisfying the script. Bob's unlocking script must then comprise a solution to the cryptographic puzzle, and additionally satisfy one of at least two alternative options in the second conditional clause sub-script. Alice and Bob may come to an agreement of a protocol regarding the precise option and what they symbolise. For example, Alice and Bob may agree that one condition is that Bob provides the pre-image to a hash of the word “YES”, and a second condition is that Bob provides the pre-image to a hash of the word “NO”. In this way, Bob may signal agreement or disagreement with the message in his response transaction, by choosing either the YES or NO solution path. Alternatively, one condition may be signature with a hash based on one portion of the message, while a second condition may be signature with a hash based on a different portion of the message. For example, Alice may present Bob with multiple options in the message, and Bob may sign indicating which option he prefers by generating a signature using a hash of the portion of the message referring to the preferred option.

The message may be sent in an encrypted form. The encrypted form may be generated from the message using an identity-based encryption (IBE) scheme. In IBE schemes, a public key of a user can be an arbitrary string, such as an email address or username. The associated private key can only be generated by a trusted third party, the Private Key Generator. Users submit the string they wish to use as their identity, for example their email address, to the Private Key Generator, which sends them a corresponding private key. Senders encrypt using identity string of the recipient, along with some public parameters assigned by the Private Key Generator. The recipient is able to decrypt the message using the private key they have been sent.

The request transaction 108 and/or response transaction 110 may further include a third hash based on the message. For example, the third hash may be a salted hash using a different salt to the salt used to generate the first hash. This hash may be included in the transaction as an OP_RETURN. Advantageously, the use of two differently salted hashes provides protection against a birthday-problem attack, wherein Alice may generate many versions of a message by altering minor features of the message such as formatting, and may then generate many versions of an alternative message, which she wishes to pretend that Bob has signed. It is computationally unfeasible to find a preimage that will hash to give a set target hash. However, it is much easier to find a hash collision if the target hash value is not set. If Alice generated variants of two messages—a decoy message to Bob and a malicious message—and hashed a large number of variants of both the decoy message and the malicious message, varying in insubstantial details that would affect the hash without altering the substantive content of the message, she could find a hash collision (i.e. a combination of decoy and malicious message hashing to the same value), and use this to fool Bob into signing a read receipt incorporating the shared hash value. A third salted hash is one way of making this attack computationally unfeasible, as adding a salt to the preimage will change the hash unpredictably, so the two different messages with matching hashes would not result in the same hash output after salting both with the same salt.

In some scenarios, Alice may want read receipts from multiple individuals for the same message. She may do this in a number of ways.

One approach is for Alice to create separate outputs for each party, locked to require both a solution to the cryptographic puzzle and a signature with the private key of the party. This method may be useful when Alice knows the public keys of all the parties. However, it is possible that Alice may not know the public keys of the recipients. In this case, she may base each cryptographic puzzle for each party on a salted hash, wherein each party receives a different salt. This means that each participant can solve their cryptographic puzzle, but cannot solve the cryptographic puzzle for any other parties, so cannot sign without authorization on behalf of any other parties. For example, when using the Pay to Public Key Hash method to send to two recipients, Alice may generate a first hash based on the message and a first pseudorandom number, and a second hash based on the message and a second pseudorandom number. She may then generate a first and a second private key. She may use the first private key and the first hash to generate a first value, which she may include in a first output of a request blockchain transaction 108, for example as an OP_RETURN value. She may also generate a second value based on the second private key and the second hash, and may include this value in a second output of a request blockchain transaction 108. The first and second outputs may be outputs in the same blockchain transaction, or may be separate transactions. She may send the message to two individuals, Bob and Charlie. She may also send the first pseudorandom number to Bob, and the second pseudorandom number to Charlie. Bob is then able to calculate the first hash using the message and the first pseudorandom number, and then to determine the first private key from the first value and the first hash. This allows Bob to unlock the first output. However, Bob is unable to unlock the second output, despite knowledge of the message, because he does not know the second pseudorandom number so cannot calculate the second hash. Charlie is able to calculate the second hash using the second pseudorandom number, and may use this to determine the second private key from the second value, and then may use this key to construct an unlocking script to unlock the second output.

In another example, Alice may use the R-Puzzle Hash method to send to multiple recipients. In this example, she generates a first pseudorandom number and a second pseudorandom number, and then generates a first hash based on the message and the first pseudorandom number, and a second hash based on the message and the second pseudorandom number. She then uses the first hash to generate a first public key, and the second hash to generate a second public key. Details of the generation of the first public key from the first hash may be found above. A corresponding method is used to generate the second public key from the second hash. Alice then constructs a request blockchain transaction 108 with a first locking script ensuring that a first output can only be unlocked by a signature comprising a first private key corresponding to the first public key. She also constructs a request blockchain transaction 108 with a second locking script ensuring that a second output can only be unlocked by a signature comprising a second private key corresponding to the second public key. The second output and first output may be incorporated into a single blockchain transaction, or may be incorporated into distinct blockchain transactions. She then sends Bob and Charlie the message, and sends the first and second pseudorandom numbers to Bob and Charlie respectively. This means that Bob may unlock only the first output, and Charlie may unlock only the second output, despite the message being the same in both cases.

In a further example, Alice may use the Hash Reveal method to send a read receipt request to multiple recipients. In this example, Alice generates a first pseudorandom number and a second pseudorandom number. She generates a first hash based on the message and the first pseudorandom number, and a second hash based on the message and the second pseudorandom number. She then generates a third hash based on the first hash, and a fourth hash based on the second hash. She constructs a request blockchain transaction 108 comprising a first locking script which requires a corresponding unlocking script to include the preimage of the third hash. She also constructs a second locking script which requires a corresponding unlocking script to include the preimage of the fourth hash. She may use this second locking script to lock a second output of the request blockchain transaction 108. Alternatively, she may incorporate this second locking script into a second transaction. She sends the message to Bob and Charlie, and sends the first pseudorandom number to Bob, and the second pseudorandom number to Charlie. Bob and Charlie are then both able to prove receipt of the message, but neither is able to unlock both outputs without exchanging the pseudorandom numbers.

In all examples, the method may be generalised to n recipients, wherein Alice generates n pseudorandom numbers and uses these as the basis for n different cryptographic puzzles based on the message.

### 7. Example Implementation of Blockchain-Based Read Receipt

This section provides further specific examples of the blockchain-based read receipt protocol presented above. Some or all of the features described below may be used in conjunction with any of the features described above. It will be appreciated that some features are optional.

One reason for using a blockchain-based read receipt is that it is tamper-proof for both recipients and senders, whereas the off-chain one is not. Another reason is that such a mechanism can not only prove that the sent message or document has been opened, but also that its content has been read by the recipient, if necessary. Blockchain-based read receipts also allow the read receipt to be based on a portion of the message, for example a portion which is particularly pertinent to the recipient and so should be read. The described protocol also incentivises the recipients to send a read receipt.

A blockchain-based read receipt is defined as a blockchain transaction sent from the recipient to the sender, and used to confirm that the message was opened and read. As a read receipt is requested by the message sender, it is advantageous for the sender and recipient to discuss how to send a request and response blockchain transaction before generating a request blockchain transaction.

The request may be sent off-chain or on-chain. The off-chain request may be similar to the one in the existing message systems (such as Outlook and Gmail) where the sender turns on the feature requesting read receipt for all messages sent or a single message. For example, in Outlook® you can request a read request using the two methods described in section 6.

However, with existing systems there is not enough motivation for the recipients to send back an on-chain read receipt if using the off-chain request method. This is because recipients must pay some funds to publish the on-chain read receipt. In addition, if the request is sent using the second method in section 6 for a single message, it is difficult for the sender to retrieve the request if the recipient declines it. This is because it is difficult for the sender to keep track of whether such a request was sent without receiving an associated read receipt.

The on-chain request protocol described herein addresses these problems. First of all, the on-chain request transaction can be retrieved on the blockchain. Secondly, it can fund the recipients to send back the read receipt. This will further incentivize recipients to send the read receipt.

7.1 Example Scenarios of Read receipts

A sender, say Alice 103a, may send a message to one or multiple recipients and request the corresponding read receipts. Note that the message may be, for example, a normal email, or a smartphone text. It does not have to be sent on-chain, but the message system is one that allows Alice to send an on-chain request blockchain transaction. Additionally, it doesn't matter whether Alice knows the recipient's public key, the request can be sent through some customised locking script, allowing the recipient to send a read receipt by unlocking the bitcoins locked in the request transaction TxID_{request}.

The sender may request one or multiple read receipts for the same message. The scenario for requesting multiple read receipts does happen in the real-world. For instance, Alice sends an advertisement to unspecified groups of people and requests read receipts. People get paid if they return read receipts. This is helpful for the sender to count the number of people who have opened the advertisement. Additionally, the sender can have specific requirements for the read receipt, for example, proving the message not only has been opened, but also has been read.

### 7.2 One Read Receipt

The sender (Alice) sends a message M to one recipient (Bob) and requests a read receipt. The hash of the entire message is denoted as k=H(M), which Bob needs to prove to Alice that he has read the message in the read receipt. There are two types of methods that allow Alice to construct a request blockchain transaction that Bob uses to send the proof of a read receipt in a response blockchain transaction.

### 7.3 Pay to Public Key Hash Example

When Alice creates the request transaction, she may or may not know Bob's public key used in the request.

### 7.3.1 P2PKH-UnknownPK Method

Alice generates a random private key sk and combines it with k in this way Cₖ=sk+k. She creates a P2PKH-UnknownPK request transaction paying to the public key sk·G, where ‘·’ denotes elliptic curve scalar multiplication and G is the elliptic curve generator point. She appends Cₖ as the OP_RETURN data in the locking script. The hash of the entire message k is the secret value. Therefore, only users who receive the message can compute k=H(M), and can then derive sk from Cₖ to spend the UTXO of the request transaction. The P2PKH-UnknownPK request transaction TxID_{request} looks like this:

TxID_{request}

| Input | Output |
|---|---|
| <unlocking script> | OP_DUP OP_HASH160 <H(sk · G)> |
| | OP_EQUALVERIFY OP_CHECKSIG |
| | OP_RETURN <Cₖ> |

Note that once this method is adopted by the message system, the construction of Cₖ=sk+k can be automated. That is, senders and recipients do not need to have additional communication for this construction. When Alice published the request transaction, she sends Bob a read receipt template which includes the outpoint <TxID_{request}∥0>, allowing Bob to spend the UTXO. As such, the read receipt looks like this:

TxID_{read}

Input

| Outpoint | Unlocking script | Output |
|---|---|---|
| <TxID_{request}\|\| 0> | <SIGₛₖ><sk · G> | <locking script> |

Argument of security: the knowledge of k e.g. the message should be the only way to recover sk. This holds because under the random oracle model, k and H(sk·G) are indistinguishable from random. Thus, one cannot learn anything from sk in this locking script, proving the zero-knowledge aspect of this method.

We summarize the locking script as follows:

P2PKH-UnknownPK Method a - Locking script:
OP_DUP OP_HASH160 <H(sk · G)> OP_EQUALVERIFY
OP_CHECKSIG OP_RETURN <Cₖ>
P2PKH-UnknownPK Method a - Unlocking script:
<SIGₛₖ> <(sk · G)>

Although the P2PKH-UnknownPK method a can confirm that the read receipt is sent, it is not able to prove that it is sent by Bob. Anyone with knowledge of the message M can claim that he or she sent the read receipt because the read receipt does not reveal any identity-related information. To address this problem, the locking script and unlocking script may be constructed like this:

P2PKH-UnknownPK Method b - Locking script:
OP_OVER OP_HASH160 <H(sk · G)> OP_EQUALVERIFY [Point
Addition]
OP_CHECKSIG OP_RETURN <Cₖ>
P2PKH-UnknownPK Method b - Unlocking script:
<SIGₛₖ₊ₛₖ_{_{B}}> <(sk · G)> <PK_{B}>

where
PK_{B} is Bob's public key and sky is the associated private key,
SIGₛₖ₊ₛₖ_{_{B}} has to be computed with private key (sk+sk_{B}),
and [Point Addition] allows for adding two points (public keys) in script

The locking script construction in P2PKH-UnknownPK method b allows Bob to add his public key PK_{B} to the unlocking script and prove to Alice that he is the one sending the read receipt. This construction is useful for Alice to send the request transaction without knowing Bob's public key but allowing Bob to authenticate himself. It also provides Alice the flexibility to redeem the locked funds if Bob does not send the read receipt. Alice can redeem the funds using the following unlocking script:

$$< {SIG}_{s k + s {k}_{A}} > < ( sk \cdot G ) > < P {K}_{A} >$$

where PK_{A} is Alice's public key and sk_{A} is the associated private key, SIGₛₖ₊ₛₖ_{_{A}} has to be computed with private key (sk+sk_{A}).

However, this means that this construction is also vulnerable to anyone with the knowledge of the message, who can send the read receipt by adding any public key in the unlocking script. Therefore, if Alice does not require the additional identity authentication of the read receipt, and does assume the message won't be opened/read by anyone other than Bob, the P2PKH-UknownPK method a with a smaller script size is better than b.

### 7.3.2 P2PKH-KnownPK Method

If Alice knows Bob's public key PK_{B}, then she may construct the locking script as follows.

P2PKH-KnownPK Method c - Locking script:

OP_HASH160 <H(sk · G)> OP_EQUALVERIFY OP_DUP
OP_HASH160 <H(PK_{B})>
OP_EQUALVERIFY OP_CHECKSIG OP_RETURN <Cₖ>

Bob may unlock the funds via the unlocking script <SIGₛₖ_{_{B}}><PK_{B}>< (sk·G)>, where SIGₛₖ_{_{B}} is computed with the private key sk_{B}.

It is worth noting that the locking script in P2PKH-KnownPK method c does not allow Alice to redeem the locked funds if Bob does not send the read receipt. In addition, Alice cannot construct this locking script if she does not know PK_{B}.

To address the problem that Alice cannot redeem the locked funds in P2PKH-KnownPK method c, we add Alice's public key into a multisig-based locking script, as shown below.

P2PKH-KnownPK Method d - Locking script:

OP_HASH160 <H(sk · G )> OP_EQUALVERIFY OP_1 <PK_{A}>
<PK_{B}> OP_2
OP_CHECKMULTISIG OP_RETURN <Cₖ>

The corresponding unlocking script is <SIGₛₖ_{_{A}}_{/sk}_{_{B}}><PK_{A}/PK_{B}><(sk·G)>. If SIGₛₖ_{_{A}} and PK_{A} are displayed in the unlocking script, it means Alice redeemed the locked funds by herself. Remarks:
P2PKH-KnownPK method c has a smaller locking script size compared with P2PKH-KnownPK method d, but it does not allow Alice to redeem the funds if Bob did not send the read receipt.
P2PKH-KnownPK method d has a larger locking script size of 128 bytes, but it provides Alice the flexibility to redeem the funds.

It is worth noting that P2PKH-KnownPK method c and d tend not to embed the hash value of the message into Bob's public key. There are two reasons for no embedding. Firstly, this can be consistent with the locking script construction of the previous P2PKH methods. Secondly, it allows a third party (e.g., an auditor) to verify the integrity of the message for some reasons knowing the message itself.

### 7.4 Pay to R-Puzzle Hash Example

The P2RPH technique is another method of including the hash value of the message into the locking script. The details of the P2RPH method in the cases of known/unknown Bob's public key are described below.

### 7.4.1 P2Rph-Knownpk

R-puzzles can be used to prove the knowledge of k by revealing r=[k·G]ₓ. The P2RPH-UnknownPK method a has the similar characteristic to P2PKH-UnknownPK method a that anyone with the knowledge of the message can spend the UTXO of the request transaction. Moreover, this P2RPH-UnknownPK method a also allows the recipient to prove that the read receipt is sent by himself/herself. The locking script of P2RPH-UnknownPK method a is constructed as follows.

P2RPH-UnknownPK Method a - Locking script:

OP_DUP OP_3 OP_SPLIT OP_NIP OP_1 OP_SPLIT OP_SWAP
OP_SPLIT OP_DROP
OP_HASH160 <H(r)> OP_EQUALVERIFY OP_OVER
OP_CHECKSIGVERIFY OP_CHECKSIG

The unlocking script in the read receipt looks like this:

P2RPH-UnknownPK Method a - Unlocking script:

<SIG> <PK> <SIGᵣ>
Again SIG may be SIGₛₖ_{_{B}} or SIGₛₖ_{_{A}} when Alice wants to redeem the
request transaction which is not redeemed by Bob, and PK is PK_{B} or PK_{A}.
For simplicity, only the cases of SIGₛₖ_{_{B}} and PK_{B} in the following sections,
where Bob sends the read receipt.

If Alice knows Bob's public key PK_{B}, then the locking script of the request transaction can be constructed as follows.

P2RPH-KnownPK Method b - Locking script:

OP_HASH160 <H(PK_{B})> OP_EQUALVERIFY
OP_DUP OP_3 OP_SPLIT OP_NIP OP_1 OP_SPLIT OP_SWAP OP_SPLIT
OP_DROP
OP_HASH160 <H(r)> OP_EQUALVERIFY OP_OVER OP_CHECKSIGVERIFY
OP_CHECKSIG

The corresponding unlocking script in the read receipt may be constructed as follows:

P2RPH-KnownPK Method b - Unlocking script:

<SIG> <PK> <SIGᵣ> <PK_{B}>
Note that PK may be PK_{B}, and then the corresponding SIG is SIGₛₖ_{_{B}} from
PK_{B}. In fact, PK is used to generate the signature SIGᵣ and SIG, but the
signature SIG uses a different r-value from r to avoid signature forgery.

An alternative construction of the locking script and unlocking script is shown below:

P2RPH-KnownPK Method c - Locking script:
OP_OVER OP_HASH160 <H(PK_{B})> OP_EQUALVERIFY
OP_DUP OP_3 OP_SPLIT OP_NIP OP_1 OP_SPLIT OP_SWAP OP_SPLIT
OP_DROP
OP_HASH160 <H(r)> OP_EQUALVERIFY OP_OVER OP_CHECKSIGVERIFY
OP_CHECKSIG
P2RPH-KnownPK Method c - Unlocking script:
<SIGₛₖ_{_{B}}> <PK_{B}> <SIGᵣ>

### Remarks:

The locking script in P2RPH-KnownPK method b allows Alice (or anyone with the knowledge of the message) to redeem the locked output if Bob does not send the read receipt. In addition, if the read receipt is sent by Bob, then his public key can be used by Bob to prove his sending if Alice asks him to authenticate the read receipt. However, the vulnerability of this method is that anyone who knows the message and Bob's public key PK_{B} can claim the funds.
The locking script in P2RPH-KnownPK method c locks the bitcoins that can only be spent by Bob.

The locking script in P2RPH-UnknownPK method a allows Bob to prove that he sent the read receipt. If he does not send the read receipt, Alice can redeem the funds. However, it has the same flaw as P2PKH-UnknownPK method b and P2RPH-KnownPK method b, i.e., anyone who knows M is able to spend the UTXO. As such, how to construct the locking script of the request transaction depends on Alice's needs.

As can be seen, for the P2RPH-KnownPK method b and c, Bob can use the public key PK_{B} in the unlocking script to prove that the read receipt is sent by him. Bob can achieve this proof in a number of ways. For example, PK_{B} is the one linked with his identity. An alternative is that Bob shows his control of the private key associated with PK_{B}, such as paying some bitcoins to PK_{B} and then unlocking them.

To allow Bob to send such a read receipt, Alice also needs to send Bob the outpoint of TxID_{request}, which will be used for the read receipt's input. This is because the request transaction is not paid to Bob's public key directly, Bob needs to spend that UTXO of the request transaction and then pay himself to obtain the funds. Bob fills in the corresponding unlocking script and locking script in the read receipt transaction template and publishes TxI_{Dread} on the blockchain. The message system (e.g., Outlook or Gmail) may be linked to wallet services that allows signature and transaction generation. In doing so, Bob can authorize the message system to automatically send the read receipt by simply utilising the hash value of the entire message after he opens the message.

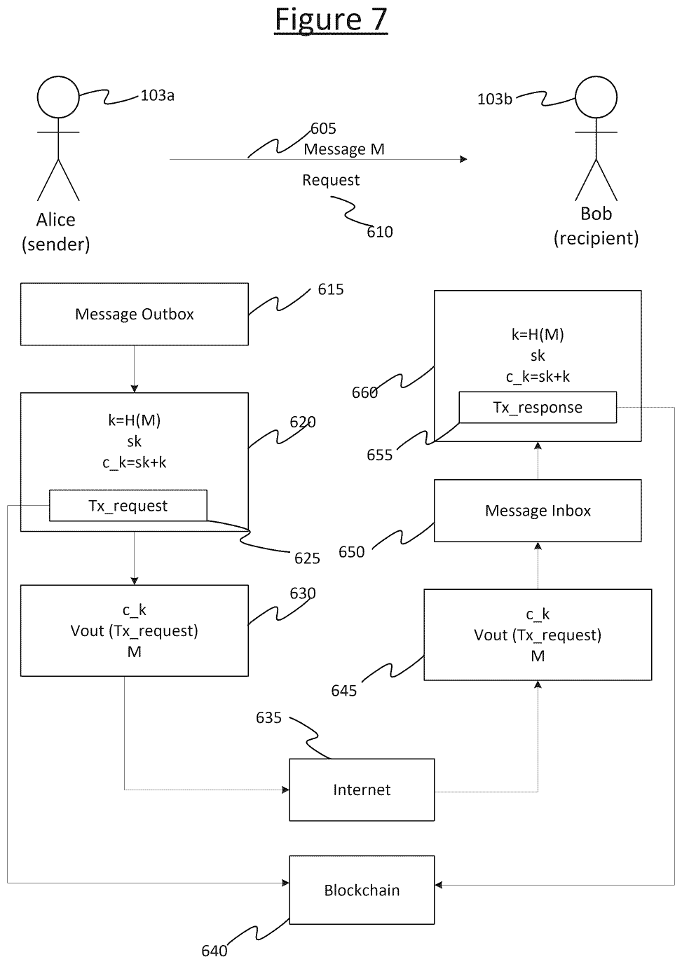

This may be done with a pop up that appears on Bob's screen and displays an option that directly uses the hash value of the entire message. After confirming this option (by Bob), the message system computes sk and r for Bob, and generates the corresponding signature. The process of sending a request from Alice and replying with a read receipt from Bob is described in FIG. 7.

FIG. 7 illustrates the process of sending a read receipt from Alice 103a to Bob 103b. Alice composes a message and places it in her Message Outbox 615. The message outbox 615 sends the message M to Bob 103b in step 605, and also calculates a cryptographic puzzle based on the message in step 620. The Message Outbox constructs a request blockchain transaction, Tx_request 625, and sends this draft transaction to a wallet manager. The wallet manager completes the transaction Tx_request 625 and sends the completed transaction to the blockchain 640. Bob's wallet manager received Tx_request 625 from the blockchain 640, and at step 645 it communicates the cryptographic puzzle to Bob's message manager. The message manager at 660 computes the solution to the cryptographic puzzle. Bob chooses to send a response by accepting the response transaction Tx_response 655 proposed by the message manager, which the message manager then sends to the blockchain 640. Alice then observes this response transaction 655 on the blockchain to confirm that Bob has received the message M.

Note that this option only requires that Bob ticks the option to confirm the message opened, authorize the message system to generate his signature, and then send the read receipt. Such a read receipt is called an open read receipt because Bob can send it without reading the details of the message. In doing this, it may be difficult to avoid others sending such an ‘open’ read recipient on behalf of Bob. For example, Bob leaves his desk without locking his laptop, others may check his emails and click to send the read receipt. This is a similar downside to the read receipt method in the existing email system described in Section 6. But the described protocol method is able to provide Bob the immutable evidence of sending such a read receipt on the blockchain. When such an unexpected read receipt is sent, Bob may receive a notification from his wallet that some funds have been received.

So far, P2PKH and P2RPH methods serve the simplest case for one read receipt and without any complicated requirements. Sometimes, senders may not only ask for confirmation that the message was opened, but also that its content was read. For example, the message includes an annual yield report, and Alice requires Bob to confirm some information M′, which may be some critical data in that report. The hash value of such information is denoted as k′=H(M′). In this case, for the P2PKH solutions, Alice needs to generate another private key skₖ, and compute C_{k′}=sk_{k′}+k′. Bob may have to read the report to compute k′=H(M′) that will be used to compute sk_{k′}=C_{k′}−k′. For the P2RPH solutions, r′= [k′·G]ₓ.

In order for Bob to confirm M′, the message system may offer a second option in the pop up. This second option will require Bob to confirm the reading of a particular piece of information M′. After Bob obtained the required information from the message, he can enter k′=H (M′) into the system. Once k′ is entered, the computation of sk_{k′}=C_{k′}−k′ or r′= [k′·G]ₓ is triggered. The message system then generates the corresponding signature and sends the read receipt.

One thing we may be concerned with is that Bob could use some technical tools instead of reading it himself to grab the content that Alice specifies. If Bob does this, we call his behaviour cheating and consider this message is opened not read. Bob enters the grabbed information into the message system. The entered information is used to generate SIGᵣ, over r′. Note that the message system is assumed to only allow automatic generation of SIGₛₖ/SIGₛₖ₊ₛₖ_{_{B}} and SIGᵣ, instead of SIG_{sk′}/SIG_{sk′+sk}_{_{B}} and SIG_{r′}. In this case, the read receipt is used as proof that Bob agrees to the specified information. If there is any dispute about the information, he must be responsible for his read receipt. Thus, Bob's cheating will only negatively affect Bob as he did not read and check the information by himself but claimed he did.

### 7.5 Read and Agree, or Read but Disagree

Sometimes, Alice may ask Bob to confirm that something in the message, such as the proposed bid price for a project, is accurate. Bob disagrees with the bid price but still wants to send a read receipt confirming his read and disagreement. To achieve this, suppose Alice knows Bob's public key PK_{B}, she can add a conditional clause to the locking script in the request transaction, see below.

```
P2PKH-KnownPK Method c′ - Locking script:
OP_DUP OP_HASH160 <H(sk · G )> OP_EQUALVERIFY
OP_IF
  OP_DROP OP_DUP OP_HASH160 <H(PK_{B})> OP_EQUALVERIFY OP_CHECKSIG
OP_RETURN <Cₖ>
OP_ELSE
  OP_HASH160 <H(sk_{k′} · G )> OP_EQUALVERIFY
  OP_IF
    OP_DUP OP_HASH160 <H(PK_{B})> OP_EQUALVERIFY OP_CHECKSIG
OP_RETURN <C_{k′}>
    OP_ELSE
      OP_FALSE
            OP_ENDIF
        OP_ENDIF
or
P2RPH-KnownPK Method c′ - Locking script:
OP_OVER OP_HASH160 <H(PK_{B})> OP_EQUALVERIFY
OP_DUP OP_3 OP_SPLIT OP_NIP OP_1 OP_SPLIT OP_SWAP OP_SPLIT
OP_DROP
OP_DUP OP_HASH160 <H(r′)> OP_EQUALVERIFY
OP_IF
            OP_DROP OP_OVER OP_CHECKSIGVERIFY OP_CHECKSIG
OP_ELSE
  OP_HASH160 <H(r)> OP_EQUALVERIFY
  OP_IF
  OP_OVER OP_CHECKSIGVERIFY OP_CHECKSIG
  OP_ELSE
    OP_FALSE
          OP_ENDIF
        OP_ENDIF
If Bob unlocks the funds with SIG_{sk′} or SIG_{r′}, this means that he agrees the specified
contents in the message. In addition to this, he can unlock the output with SIGₛₖ or SIGᵣ to
confirm that he has read the message but does not agree with the information M′.
```

Note that each opcode in the locking script is calculated 1 byte, and the sizes of other inputs are calculated as follows:
< >: 1 byte. It represents an opcode used to push the data onto the stack
Compressed public key: 33 bytes
HASH160 address: 20 bytes
Cₖ (the same size as a private key): 32 bytes
SIG: 73 bytes
Point addition: 100+bytes

The characteristics of all example techniques in Table 1.

TABLE 1
Characteristic of P2PKH and P2RPH methods.

| | | Locking | Unlocking | Overall | | | Funds |
|---|---|---|---|---|---|---|---|
| | | script | script | script | | Allow Bob to | redeemed |
| | | size | size | size | PK_{B}_{ᵢ} | authenticate | by |
| Methods | index | (bytes) | (bytes) | (bytes) | included | himself | Alice |
| P2PKH- | a | 59 | 108 | 167 | No | No | Yes |
| Unknown | b | 159+ | 142 | 301+ | No | Yes | Yes |
| PK | | | | | | | |
| P2PKH- | c | 82 | 142 | 224 | Yes | Yes | No |
| KnownPK | d | 128 | 142 | 270 | Yes | Yes | Yes |
| P2RPH- | a | 55 | 182 | 237 | No | Yes | Yes |
| Unknown | | | | | | | |
| PK | | | | | | | |
| P2RPH- | b | 58 | 216 | 274 | Yes | Yes | Yes |
| KnownPK | c | 59 | 182 | 241 | Yes | Yes | No |

In all example techniques, the P2RPH-UnknownPK method a has the smallest locking script and the second smallest overall script size. It provides Alice the flexibility to redeem the funds and Bob to authenticate himself. In addition, if Bob's public key is associated with his identity, this method of not including his public key in the locking script will preserve his privacy. However, this method may not achieve all these benefits in the context of multiple read receipts. More details will be discussed in the next section.

### 7.6 Multiple Read Receipts

Sometimes, Alice may send a request to multiple recipients for more than one read receipt. Similar to the scenario of one read receipt, the request transaction is also generated based on a different context, e.g., Alice's may or may not know recipients' public keys that are used to unlock the funds of the request transaction.

Assume Alice does not have any specific requirements for read receipts, and she does create a n-request transaction that has n outputs. For simplicity, we only consider constructing the locking script of each output using the same method, e.g., the P2PKH-KnownPK method c. However, it is also acceptable if the locking script of each output is constructed with a different method. For example, the first output uses the P2PKH-KnowPK method c, and the second output uses the P2PKH-Known method d.

### 7.6.1 Recipients' Public Keys are Known

Alice may send the same message to multiple recipients and require their corresponding read receipts. The locking script of each output can be constructed according to the P2PKH-KnownPK method c, d, and P2RPH-KnownPK method b, c. However, the P2RPH-KnownPK method b is vulnerable for Alice because she may receive the multiple read receipts from the same recipient who has the knowledge of the message M. The P2PKH-KnownPK method c and P2RPH-KnownPK method c only allow recipients to spend the locked funds. For these two methods, the sender of the request is not able to redeem the funds if the recipients do not send the read receipts. But we still introduce the P2RPH-KnownPK method c as an example of the P2RPH-KnownPK method in the case of multiple read receipts. The P2PKH-KnownPK method d can lock the funds that are spent by either the recipient or the sender. As such, we discuss the P2PKH-KnownPK method d and the P2RPH-KnownPK method c in this section.

### 7.6.1.1 P2PKH-KnownPK Method d

Assume Alice sends the same message M to different recipients, then she creates Cₖ=sk+k for each recipient Bᵢ. The n-request transaction based on the P2PKH-KnownPK method d looks like this:

TxID_{n-request}_{₁}

| | Outputs | |
|---|---|---|
| Input | Value | Locking script |
| <unlocking | b₁ | OP_HASH160 <H(sk · G)> OP_EQUALVERIFY |
| script> | | OP_1 <PK_{A}> <PK_{B}_{ᵢ}> OP_2 |
| | | OP_CHECKMULTISIG OP_RETURN <Cₖ> |
| | . . . | . . . |
| | bₙ | OP_HASH160 <H(sk · G)> OP_EQUALVERIFY |
| | | OP_1 <PK_{A}> <PK_{B}_{ₙ}> OP_2 |
| | | OP_CHECKMULTISIG OP_RETURN <Cₖ> |

The recipient Bᵢ can spend the UTXO with the following unlocking script of the read receipt: P2PKH-KnownPK method c-Unlocking script:

$$< {SIG}_{s {k}_{{B}_{i}}} > < P {K}_{{B}_{i}} > < sk \cdot G >$$

The parameters in the TxID_{n-request}_{₁} and the read receipt are described below.
PK_{B}, is the public key of the i-th recipient known to Alice, and i=1, . . . , n;
sk_{B}_{ᵢ} is the private key associated with PK_{B}_{ᵢ};

$${SIG}_{s {k}_{{B}_{i}}}$$

is computed with sk_{B}_{ᵢ}; and
bᵢ is the amount that each recipient can obtain by sending a read receipt, and it could be different or the same depending on Alice's needs. In addition, the amount of bᵢ could be valuable or just dust, depending on how important Alice thinks the read receipt is.

It is worth noting that even though sk·G and Cₖ are the same for all recipients, the fund bᵢ only can be spent by Bᵢ and Alice. This example is useful for Alice to send the same message to a group of recipients and receive distinguishable read receipts from each. Importantly, if the sender did not redeem the funds, then bᵢ can only be spend by Bᵢ even if Bᵢ's secret sk is leaked to other recipients.

If Alice sends different messages Mᵢ to different recipients, then kᵢ=H(Mᵢ). The construction of Cₖ for each recipient Bᵢ is computed such that Cₖ_{ᵢ}=skₖ_{ᵢ}+kᵢ, where skₖ_{ᵢ} is different for each recipient Bᵢ. The i-th output in TxID_{n-request}_{₁} is constructed as follows:

P2PKH-KnownPK method d - Locking script:

OP_HASH160 <H(skₖ_{ᵢ} · G)> OP_{—}_{EQUALVERIFY OP}_{_{—}}_{1 <PK}_{_{A}}_{> <PK}_{_{B}}_{ᵢ}> OP_2
OP_CHECKMULTISIG OP_RETURN <Cₖ_{ᵢ}>

### 7.6.1.2 P2RPH-KnownPK Method c

The n-request transaction based on the P2RPH-KnownPK method c looks like this:

TxID_{n-request}_{₂}

| | Outputs | |
|---|---|---|
| Input | Value | Locking script |
| <unlocking | b₁ | OP_OVER OP_HASH160 <H(PK_{B}_{₁})> |
| script> | | OP_EQUALVERIFY OP_DUP OP_3 OP_SPLIT |
| | | OP_NIP OP_1 OP_SPLIT OP_SWAP |
| | | OP_SPLIT OP_DROP OP_HASH160 <H(r)> |
| | | OP_EQUALVERIFY OP_OVER |
| | | OP_CHECKSIGVERIFY OP_CHECKSIG |
| | . . . | . . . |
| | bₙ | OP_OVER OP_HASH160 <H(PK_{B}_{ₙ})> |
| | | OP_EQUALVERIFY OP_DUP OP_3 OP_SPLIT |
| | | OP_NIP OP_1 OP_SPLIT OP_SWAP |
| | | OP_SPLIT OP_DROP OP_HASH160 <H(r)> |
| | | OP_EQUALVERIFY OP_OVER |
| | | OP_CHECKSIGVERIFY OP_CHECKSIG |

The unlocking script of the i-th read receipt sent by the recipient B; is:

P2RPH-KnownPK method c - Unlocking script:

<SIG [symbol] > <PK_{B}_{ᵢ}> <SIGᵣ>

where SIG_{B}_{ᵢ} is generated from PK_{B}_{ᵢ}, but a different r value from r=[k·G]ₓ.

For simplicity, we set the same r value in each output in the TxID_{n-request}_{₂}. In fact, each output can be seen like a single request in the context of one read receipt, that is, Alice constructs the locking script of each output related to different values of rᵢ=[kᵢ·G]ₓ as follows:

P2RPH-KnownPK method c - Locking script:

OP_OVER OP_HASH160 <H(PK_{B}_{ᵢ})> OP_EQUALVERIFY
OP_DUP OP_3 OP_SPLIT OP_NIP OP_1 OP_SPLIT OP_SWAP OP_SPLIT
OP_DROP OP_HASH160 <H(rᵢ)> OP_EQUALVERIFY OP_OVER
OP_CHECKSIGVERIFY OP_CHECKSIG

In the scenario of multiple requests, the locking script is constructed by using either the P2PKH-KnownPK method d or the P2RPH-KnownPK method c. This is useful for Alice to send the same/different message to different recipients and lock funds individually. In addition, recipients can only spend their corresponding UTXOs regardless of whether they receive the same message or a different one. Note that the P2RPH-KnownPK method d has a larger locking script size with (128×n) bytes, but it provides Alice the flexibility to redeem the funds.

### 7.6.2 Recipients' Public Keys are Unknown

The request transaction described above cannot be adapted if Alice does not know any public keys PK_{B}_{ᵢ}. In this case, we may need to consider the P2PKH-UnknownPK method a, b or the P2RPH-Unknown method a to construct the locking script of the n-request transaction.

But these examples cannot be applied directly to the scenario of multiple read receipts when the same message is sent to multiple recipients. Because senders sending the same message to multiple recipients may not be able to receive distinguishable read receipts, or a single recipient may send the read receipts that were supposed to be sent by other users.

Taking the P2RPH-Unknown method a as an example, in the scenario of one read receipt, Alice can just make use of one r value to generate the request transaction that only Bob can spend. This works because only Bob receives the message and knows how to compute r=[k·G]ₓ. In the scenario of multiple read receipts, each output only includes the same r value, which makes each output possible to be spent by the same recipient. This is not what Alice wants to achieve in the context of multiple read receipts. To solve this problem, Alice needs to make each output distinguishable, even with the same r value.

One possible way we proposed is to concatenate a random nonce zᵢ with the message M, and then the hash value is H(M∥zᵢ) for the recipient Bᵢ. Zᵢ can be generated by the pseudo-random number generator and make it unpredictable. Note that we do not use a sequence nonce because it may be easy for recipients to guess the value of the next one zᵢ₊₁. We assume that z; can be securely sent separately to each recipient and identified directly by the recipient's message system. How to achieve this is beyond the scope of this paper.

The details of how to embed zᵢ in the P2PKH-UnknownPK method b and the P2RPH-Unknown method a are discussed below. Note that we only discuss within the context of sending the same message to different recipients because sending different messages to different recipients naturally makes each output distinguishable. That is, we can directly apply the P2PKH-UnknownPK method b or the P2RPH-Unknown method a when sending different messages. Furthermore, zᵢ is only a value to help Alice allocate requests to multiple recipients, but it is not the information we mentioned in section 3.1 that Alice wants to confirm.

### 7.6.2.1 P2PKH-UnknownPK Method a

zᵢ is generated by Alice and allocated to each recipient Bᵢ. Now C_{k|z}_{ᵢ}=sk_{k|z}_{ᵢ}+H(M∥zᵢ), where sk_{k|z}_{ᵢ} is generated by Alice for the recipient Bᵢ. Note that sk_{k|z}_{ᵢ} is different for each recipient Bᵢ. As such, the i-th locking script in the request transaction can be constructed like this:

P2PKH-UnknownPK Method a - Locking script:
OP_HASH160 <H(sk_{k|z}_{ᵢ} · G)> OP_{—}_{EQUALVERIFY OP}_{_{—}}_{CHECKSIG}
OP_RETURN
<C_{k|z}_{ᵢ}>
P2PKH-UnknownPK Method a - Unlocking script:
<SIG [symbol] > <(sk_{k|z}_{ᵢ} · G)>

### 7.6.2.2 P2PKH-UnknownPK Method b

P2PKH-UnknownPK Method b - Locking script:
OP_OVER OP_HASH160 <H(sk_{k|z}_{ᵢ} · G)> OP_{—}_{EQUALVERIFY [Point Addition]}
OP_CHECKSIG OP_RETURN <C_{k|z}_{ᵢ}>
P2PKH-UnknownPK Method b - Unlocking script:
<SIG [symbol] > <(sk_{k|z}_{ᵢ} · G)> <PK_{B}_{ᵢ}>

It is worth noting that the P2PKH-UnknownPK method b is costly because the script size including [Point Addition] is very large, especially in TxID_{n-request}.

If Alice wants to confirm some information of the message M, she can just replace M with the confirmed information M′ in the P2PKH-UnknownPK method a and b.

### 7.6.2.3 P2RPH-UnknownPK Method a

When zᵢ is concatenated with message M, we can compute r_{k|z}_{ᵢ}=[H(M∥zᵢ)·G]ₓ. Now, the locking script in the P2RPH-UnknownPK method a can be constructed as follows:

P2RPH-UnknownPK Method a - Locking script:
OP_DUP OP_3 OP_SPLIT OP_NIP OP_1 OP_SPLIT OP_SWAP OP_SPLIT
OP_DROP OP_2 OP_ROLL OP_CAT OP_HASH160 <H(r_{k|z}_{ᵢ})> OP_EQUALVERIFY
OP_OVER OP_CHECKSIGVERIFY OP_CHECKSIG
P2RPH-UnknownPK Method a - Unlocking script:
<SIG [symbol] ><PK_{B}_{ᵢ}><SIG [symbol] >

If Alice would like to confirm some information of the message, she can simply add the conditional clause into the locking script:

P2RPH-UnknownPK Method a′ - Locking script:

```
OP_DUP OP_3 OP_SPLIT OP_NIP OP_1 OP_SPLIT OP_SWAP OP_SPLIT
OP_DROP
OP_DUP OP_3 OP_ROLL OP_TUCK OP_CAT OP_HASH160 <H(r_{k′|z}_{ᵢ}_{-B}_{ᵢ})>
OP_EQUALVERIFY
OP_IF
          OP_2DROP OP_OVER OP_CHECKSIGVERIFY OP_CHECKSIG
OP_ELSE
  OP_CAT OP_HASH160 <H(r_{k|z}_{ᵢ}_{-B}_{ᵢ})> OP_EQUALVERIFY
  OP_IF
  OP_OVER OP_CHECKSIGVERIFY OP_CHECKSIG
  OP_ELSE
    OP_FALSE
        OP_ENDIF
      OP_ENDIF
```

Then the unlocking script in the read receipt to this locking script is:

P2RPH-UnknownPK Method a′ - Unlocking script:

<SIG [symbol] ><PK_{B}_{ᵢ}><SIG [symbol] >

The steps for sending a read receipt are summarised in FIG. 7.

### 7.7 Discussion

The existing read receipt method using conventional methods is known only to the sender. When someone other than the message recipient (Bob) sends the read receipt, Bob cannot detect it. The blockchain-based read receipt protocol allows Bob to detect it via receiving a notification from his wallet e.g. that some funds have been received. In addition, it enables Bob to obtain the immutable evidence of such unexpected read receipts from the blockchain.

It also provides senders the tamper-proof requests and read receipts. Senders publish the request transactions to prove that they have sent the message to the recipients and requested a corresponding read receipt. Senders can select an appropriate method based on their needs.

### 7.8 Sending Encrypted Messages Under IBE Scheme

In some examples, Alice may send an encrypted message to Bob and request a read receipt about the associated decrypted content. One way of encrypting the message is to use an identity-based encryption scheme where a public key of a user can be an arbitrary string such as an email address or a username. That is, when using the identity-based encryption in the message system, we no longer need to consider the problem that the sender does not know the recipient's public key in all scenarios. Encrypting messages using the IBE scheme ensures that the message can only be decrypted by the recipient, thereby the read receipt can only be sent by the recipient. In other words, the sender does not need to ask the recipient for additional identification about the read receipt.

This section describes how the request blockchain transaction and a response blockchain transaction are generated when an identify-based encryption scheme is used in the message system.

Only the P2PKH-UnknownPK method a and the P2RPH-UnknownPK a, which do not include the recipients' public keys in the locking script, are discussed here with some modifications, but in general any of the described techniques may be used. For these methods adopted in this section, we refer to them as modified methods. There are some features that the modified P2PKH-UnknownPK method a and the P2RPH-UnknownPK method a can achieve:
The locking script is specific for each recipient.
The locking script provides senders the flexibility to redeem the locked funds once any recipient does not send a read receipt.
The locking script hides the recipients' public keys and preserves their privacy.

Here is presented the modified P2PKH-UnknownPK method a and the P2RPH-UnknownPK method a in the context of multiple read receipts. Because the i-th locking script can be considered as an individual locking script in the scenario of one read receipt.

Under IBE scheme, Alice sends a ciphertext E_{k|z}_{ᵢ} to a recipient Bᵢ instead of the message M. The ciphertext E_{k|z}_{ᵢ} is the encrypted text converted from the message M using the recipient's identity-based public key PK_{B}_{ᵢ} such as E_{k|z}_{ᵢ}=Enc(PK_{B}_{ᵢ}, M∥zᵢ, pp), where pp are the system parameters generated by the Private Key Generator run by the message system. The parameters pp are the same for all users participating in the IBE scheme. Concatenating the random nonce z with M prevents other recipients of the same message from inferring E_{k|z}_{ᵢ}. The following discusses how to use E_{k|z}_{ᵢ} in the modified P2PKH-UnknownPK method a and the P2RPH-UnknownPK method a below.

### 7.8.1 Modified P2PKH-UknownPK Method a

The P2PKH-UnknownPK method a relies on the construction of Cₖ=sk+k. Alice makes use of the message M and the associated random value z; to construct C_{k|z}_{ᵢ}=Sk_{k|z}_{ᵢ}+H(M∥zᵢ). The corresponding locking script looks like this:

Modified P2PKH-UnknownPK Method a - Locking script:

OP_DUP OP_HASH160 <H(sk_{k|z}_{ᵢ} · G)> OP_{—}_{EQUALVERIFY OP}_{_{—}}_{CHECKSIG}
OP_RETURN <C_{k|z}_{ᵢ}>

Under the IBE scheme, Alice sends the ciphertext E_{k|z}_{ᵢ}=Enc(PK_{B}_{ᵢ}_{,M}|zᵢ, pp) to a recipient Bᵢ instead of the message M. This helps Alice to confirm that the read receipt is sent by the recipient Bᵢ. This is because E_{k|z}_{ᵢ} can only be decrypted by Bᵢ, and then Bᵢ gets the M∥zᵢ to send the read receipt.

To send the read receipt and get paid, Bᵢ needs to implement the following steps:
1. Obtain the private key related to the recipient's identity (e.g., email address) from the PKG.
2. Decrypt the ciphertext E_{k|z}_{ᵢ} using the assigned private key to obtain the message M and zᵢ.
3. Compute H(M∥zᵢ).
4. Compute sk_{k|z}_{ᵢ}=C_{k|z}_{ᵢ}−H(M∥zᵢ).
5. Calculate the signature

$${SIG}_{s {k}_{k \vert {z}_{i}}}$$

sk_{k|z}_{ᵢ}.
6. Create a read receipt using the signature

$${SIG}_{s {k}_{k \vert {z}_{i}}}$$

and sk_{k|z}_{ᵢ}·G as the input.

The unlocking script in the read receipt is shown below.

Modified P2PKH-UnknownPK Method a - Unlocking script:

<SIG [symbol] > <(sk_{k|z}_{ᵢ} · G)>

### 7.8.2 Modified P2RPH-Unknown Method a

Under the IBE scheme, Alice sends the E_{k|z}_{ᵢ}=Enc(PK_{B}_{ᵢ}M∥zᵢ,pp) instead of M to each recipient. To send the read receipt, the recipient Bᵢ needs to do the following steps:
1. Decrypts E_{k|z}_{ᵢ} to get M and zᵢ.
2. Compute the hash value k=H (M∥zᵢ).
3. Compute sk_{k|z}_{ᵢ}=C_{k|z}_{ᵢ}−k
4. Take the x-coordinate from the point k·G to get r_{k|z}_{ᵢ}=[k·G]ₓ.
5. Generate a private key sk_{B}_{ᵢ}, and the associate public key PK_{B}_{ᵢ}_{′}=sk_{B}_{ᵢ}_{′}·G. Note that the PK_{B′}, is different from PK_{B}_{ᵢ} used in the encryption process.
6. Calculate the modular inverse k⁻¹ of k mod n, where n is some prime modulus.
7. Calculate s=k⁻¹(e+sk_{B}_{ᵢ}_{′}·r_{k|z}_{ᵢ}) mod n. If s=0, return to step 5 and choose another private key sk_{B}_{ᵢ}_{′}.
8. Get the signature

$${SIG}_{{r}_{k \vert {z}_{i}}} = ( {r}_{k \vert \vert {z}_{i}} , s ) .$$

9. Generate the signature

$${SIG}_{s {k}_{{B}_{{i}^{′}}}}$$

with the private key sk_{B}_{ᵢ}_{′}. Note that

$${SIG}_{s {k}_{{B}_{{i}^{′}}}}$$

signs a different message than the one signed by

$${SIG}_{{r}_{k \vert {z}_{i}}} ,$$

which could be done by using a different sighash flag. In addition, the signature

$${SIG}_{s {k}_{{B}_{{i}^{′}}}}$$

must not use k as the ephemeral key so that it does not leak the private key.
10. Create the read receipt using

$${SIG}_{s {k}_{{B}_{{i}^{′}}}} , {PK}_{{B}_{{i}^{′}}} and {SIG}_{{r}_{k \vert {z}_{i}}}$$

as the input.

Modified P2RPH-UnknownPK Method a - Locking script:
OP_DUP OP_3 OP_SPLIT OP_NIP OP_1 OP_SPLIT OP_SWAP OP_SPLIT
OP_DROP OP_2 OP_ROLL OP_CAT OP_HASH160 <H(r_{k|z}_{ᵢ})> OP_EQUALVERIFY
OP_OVER OP_CHECKSIGVERIFY OP_CHECKSIG
Modified P2RPH-UnknownPK Method a - Unlocking script:
<SIG [symbol] ><PK_{B}_{_{i′}}><SIG [symbol] >

The locking script would check that the value z; is present in the unlocking script, meaning the correct Bᵢ has sent the read receipt.

### Remarks:

The modified P2PKH-UnknownPK method a and the modified P2RPH-UnknownPK method a allow Alice to confirm that the read receipt is sent by Bᵢ through Bᵢ's decryption of E_{k|z}_{ᵢ}. More importantly, the unlocking script in the modified P2PKH-UnknownPK method a achieve this without disclosing Bᵢ's public key.
Both methods also allow Alice to redeem the locked funds if the recipient Bᵢ does not send the read receipt.

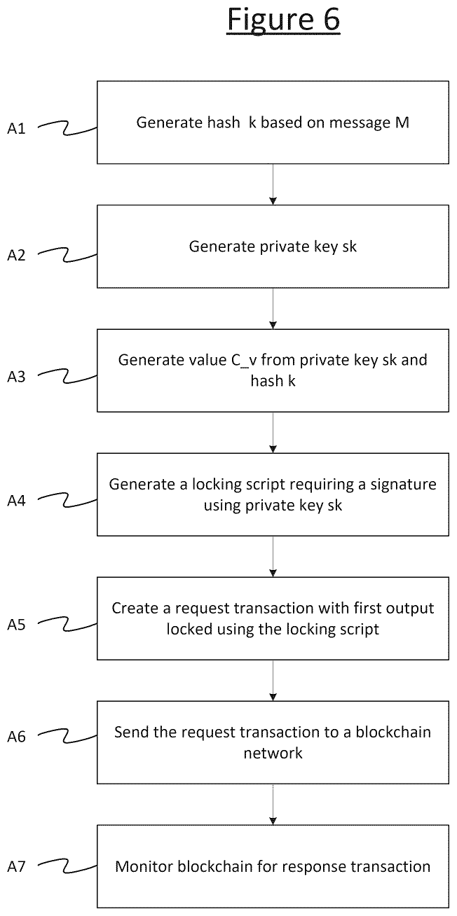

FIG. 6 is a flow chart illustrating example steps that may be taken by Alice using the Pay-to-Public-Key-Hash method described above. At step A1, Alice generates a hash k, based on the message M. At step A2, Alice generates private key sk. At step A3, Alice generates a value Cᵥ based on the private key sk and the hash k. At step A4, Alice generates a locking script that forces an unlocking script to contain a signature using sk. At step A5, Alice creates a request blockchain transaction, in which a first output is locked using the locking script. At step A6, Alice sends the request blockchain transaction to a node of the blockchain network 106, for inclusion in the blockchain. At step A7, Alice monitors the blockchain for a response blockchain transaction spending the first output of the request blockchain transaction.

### 8. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

Some embodiments have been described in terms of the blockchain network implementing a proof-of-work consensus mechanism to secure the underlying blockchain. However proof-of-work is just one type of consensus mechanism and in general embodiments may use any type of suitable consensus mechanism such as, for example, proof-of-stake, delegated proof-of-stake, proof-of-capacity, or proof-of-elapsed time. As a particular example, proof-of-stake uses a randomized process to determine which blockchain node 104 is given the opportunity to produce the next block 151. The chosen node is often referred to as a validator. Blockchain nodes can lock up their tokens for a certain time in order to have the chance of becoming a validator. Generally, the node who locks the biggest stake for the longest period of time has the best chance of becoming the next validator.

It will be appreciated that the above embodiments have been described by way of example only. More generally there may be provided a method, apparatus or program in accordance with any one or more of the following Statements.

Statement 1. A computer-implemented method of requesting a read receipt for a message using a blockchain, the read receipt evidencing that the message has been opened, the method being performed by a first party and comprising:
sending the message, and/or an encrypted version thereof, to a second party;
generating a cryptographic puzzle based on the message;
generating a request blockchain transaction, wherein the request blockchain transaction comprises a first output locked by a first locking script, wherein the first locking script is configured to, when executed together with a first unlocking script of a response blockchain transaction, require the first unlocking script to comprise a solution to the cryptographic puzzle; and
determining that the message has been opened in response to determining that the first output has been unlocked.

Statement 2. The method of claim 1, wherein the cryptographic puzzle is based on only a portion of the first message.

Statement 3. The method of Statement 1 or Statement 2, wherein said generating of the cryptographic puzzle comprises generating a first hash based on the message and generating a first value based on the first hash and a first private key, wherein the request transaction comprises the first value, and wherein the solution comprises a signature generated using the first private key.

Statement 4. The method of Statement 3, wherein the first output comprises the first value.

Statement 5. The method of Statement 3 or Statement 4, wherein the method further comprises:
generating the first hash based on the message and a first pseudorandom number;
generating a second hash based on the message and a second pseudorandom number;
sending the first pseudorandom number, and/or an encrypted version thereof, to the second party;
sending the message and the second pseudorandom number, and/or encrypted versions thereof, to a third party;
generating a second private key and a second value, wherein the second value is based on the second private key and the second hash; and wherein the request blockchain transaction comprises a second output locked by a second locking script, wherein the second output comprises the second value, wherein the second locking script requires a second unlocking script to comprise a signature with the second private key.

Statement 6. The method of Statement 1 or Statement 2, wherein said generating of the cryptographic puzzle comprises generating a first hash based on the message, generating a first public key based on the first hash, generating a second value based on an x-coordinate of the first public key, wherein the request transaction comprises a hash based on the first public key, and wherein the solution comprises a signature comprising the second value.

Statement 7. The method of Statement 6, wherein the method further comprises:
generating the first hash based on the message and a first pseudorandom number;
generating a second hash based on the message and a second pseudorandom number;
sending the first pseudorandom number, and/or an encrypted version thereof, to the second party;
sending the message and the second pseudorandom number, and/or encrypted versions thereof, to a third party; wherein the request blockchain transaction comprises a second output locked by a second locking script, wherein the second locking script requires a second unlocking script to comprise a signature by a key based on the second hash.

Statement 8. The method of Statement 1 or Statement 2, wherein said generating of the cryptographic puzzle comprises generating a first hash based on the message, and generating a third hash based on the first hash, wherein the locking script requires a first unlocking script to comprise a pre-image of the third hash.

Statement 9. The method of any preceding Statement, wherein the first locking script is configured to require the first unlocking script to comprise a signature generated using a second private key, the second private key corresponding to a second public key associated with the second party.

Statement 10. The method of any of Statements 2 to 8, wherein the first hash is based on only a portion of the first message.

Statement 11. The method of any preceding Statement, wherein the locking script is configured to carry out point addition of at least a first public key and a second public key.

Statement 12. The method of any preceding Statement, wherein the locking script comprises a first conditional clause sub-script, the first conditional clause sub-script being configured to allow unlocking of the first output on execution of a second unlocking script of a return transaction, the second unlocking script including a signature generated using a third private key.

Statement 13. The method of any preceding Statement, wherein the locking script comprises a second conditional clause sub-script, which is configured to require the first unlocking script of the response transaction to further comprise either i) a signature generated based on the first hash, or ii) a signature generating using a private key corresponding to a public key associated with the second party.

Statement 14. The method of any preceding Statement, wherein the message is sent in an encrypted form.

Statement 15. The method of Statement 14, comprising:
encrypting the message using an identity-based encryption scheme, wherein said encrypting is based on a public key associated with the second party.

Statement 16. The method of any preceding Statement, wherein the first party further sends the transaction outpoint of the request blockchain transaction to the second party.

Statement 17. A computer-implemented method of sending a read receipt for a message using a blockchain, the read receipt evidencing that the message has been opened, the method being performed by a second party and comprising:
receiving a message, and/or an encrypted version thereof;
identifying a request blockchain transaction, wherein the request blockchain transaction comprises a first output locked by a first locking script, wherein the first locking script is configured to, when executed together with a first unlocking script of a response blockchain transaction, require the first unlocking script to comprise a solution to a cryptographic puzzle;
generating a response blockchain transaction, wherein the response blockchain transaction comprises a first input that references the first output of the request transaction, the first input comprising a solution to the cryptographic puzzle, wherein the solution is based on the message.

Statement 18. The method of Statement 17, wherein the cryptographic puzzle is based on only a portion of the first message.

Statement 19. The method of Statement 17 or Statement 18, wherein the cryptographic puzzle requires knowledge of a first hash based on the message.

Statement 20. The method of Statement 17, wherein the request transaction comprises a first value based on the first hash and a first private key, and wherein the solution comprises a signature generated using the first private key.

Statement 21. The method of Statement 17, wherein the response blockchain transaction comprises a signature generated using a second private key, wherein the second private key is based on the first hash.

Statement 22. The method of Statement 17, wherein the first locking script requires the first unlocking script to comprise a pre-image of a third hash, wherein the pre-image of the third hash is based on the first hash, and wherein the first unlocking script comprises the pre-image of the third hash.

Statement 23. The method of any of Statements 17 to 22, wherein the first locking script is configured to require the first unlocking script to comprise a signature generated using a second private key, the second private key corresponding to a second public key associated with the second party, and wherein the first unlocking script comprises the signature.

Statement 24. The method of any of Statements 19 to 23, wherein the first hash is based on only a portion of the message.

Statement 25. The method of any of Statements 17 to 24, wherein the locking script comprises a conditional clause, which is configured to require the first unlocking script of the response transaction to further comprise either i) a signature generated based on the first hash, or ii) a signature that is not generated based on the first hash, and wherein the first unlocking script comprises either signature.

Statement 26. The method of any of Statements 17 to 25, wherein the message is received in an encrypted form.

Statement 27. The method of Statement 26, wherein:
said encrypted form of the message is a result of encryption of the message using an identity-based encryption scheme, wherein said encryption is based on a public key associated with the second party, and wherein the method comprises decrypting the encrypted message using a private key corresponding to the public key.

Statement 28. Computer equipment comprising:
memory comprising one or more memory units; and
processing apparatus comprising one or more processing units, wherein the memory stores code arranged to run on the processing apparatus, the code being configured so as when on the processing apparatus to perform the method of any of Statements 1 to 27.

Statement 29. A computer program embodied on computer-readable storage and configured so as, when run on one or more processors, to perform the method of any of Statements 1 to 27.

1. A computer-implemented method of requesting a read receipt for a message using a blockchain, the read receipt evidencing that the message has been opened, the method being performed by a first party and comprising:
sending the message, and/or an encrypted version thereof, to a second party;
generating a cryptographic puzzle based on the message, including generating a first hash based on the message by performing a cryptographic hashing operation on the message;
generating a request blockchain transaction, wherein generating the request blockchain transaction comprises:
generating a first output of the request blockchain transaction;
constructing a first locking script that is configured to, when executed together with a first unlocking script of a response blockchain transaction, require the first unlocking script to comprise a solution to the cryptographic puzzle,
wherein constructing the first locking script comprises constructing a conditional clause sub-script that is configured to require the first unlocking script of the response transaction to further comprise either i) a signature generated based on the first hash, or ii) a signature generating using a private key corresponding to a public key associated with the second party;
causing the request blockchain transaction to be submitted to a blockchain network;
determining that the first output of the request blockchain transaction has been unlocked; and
determining that the message has been opened in response to determining that the first output has been unlocked.

2. The method of claim 1, wherein the cryptographic puzzle is based on only a portion of the message.

3. The method of claim 1, wherein said generating of the cryptographic puzzle comprises generating a first value based on the first hash and a first private key, wherein the request transaction comprises the first value, and wherein the solution comprises a signature generated using the first private key.

4. (canceled)

5. The method of claim 3, wherein the method further comprises:
generating the first hash based on the message and a first pseudorandom number;
generating a second hash based on the message and a second pseudorandom number;
sending the first pseudorandom number, and/or an encrypted version thereof, to the second party;
sending the message and the second pseudorandom number, and/or encrypted versions thereof, to a third party;
generating a second private key and a second value, wherein the second value is based on the second private key and the second hash; and wherein the request blockchain transaction comprises a second output locked by a second locking script, wherein the second output comprises the second value, wherein the second locking script requires a second unlocking script to comprise a signature with the second private key.

6. The method of claim 1, wherein said generating of the cryptographic puzzle comprises generating a first hash based on the message, generating a first public key based on the first hash, generating a second value based on an x-coordinate of the first public key, wherein the request transaction comprises a hash based on the first public key, and wherein the solution comprises a signature comprising the second value.

7. The method of claim 6, wherein the method further comprises:
generating the first hash based on the message and a first pseudorandom number;
generating a second hash based on the message and a second pseudorandom number;
sending the first pseudorandom number, and/or an encrypted version thereof, to the second party;
sending the message and the second pseudorandom number, and/or encrypted versions thereof, to a third party; wherein the request blockchain transaction comprises a second output locked by a second locking script, wherein the second locking script requires a second unlocking script to comprise a signature by a key based on the second hash.

8. The method of claim 1, wherein said generating of the cryptographic puzzle comprises generating a first hash based on the message, and generating a third hash based on the first hash, wherein the locking script requires a first unlocking script to comprise a pre-image of the third hash.

9. The method of claim 1, wherein the first locking script is configured to require the first unlocking script to comprise a signature generated using a second private key, the second private key corresponding to a second public key associated with the second party.

10. The method of claim 2, wherein the first hash is based on only a portion of the first message.

11. The method of claim 1, wherein the locking script is configured to carry out point addition of at least a first public key and a second public key.

12. The method of claim 1, wherein the locking script comprises a first conditional clause sub-script, the first conditional clause sub-script being configured to allow unlocking of the first output on execution of a second unlocking script of a return transaction, the second unlocking script including a signature generated using a third private key.

13. (canceled)

14. The method of claim 1, wherein the message is sent in an encrypted form.

15-16. (canceled)

17. A computer-implemented method of sending a read receipt for a message using a blockchain, the read receipt evidencing that the message has been opened, the method being performed by a second party and comprising:
receiving a message, and/or an encrypted version thereof;
identifying a request blockchain transaction, wherein the request blockchain transaction comprises a first output locked by a first locking script, wherein the first locking script is configured to, when executed together with a first unlocking script of a response blockchain transaction, require the first unlocking script to comprise a solution to a cryptographic puzzle, wherein the locking script comprises a conditional clause, which is configured to require the first unlocking script of the response transaction to further comprise either i) a signature generated based on a first hash, or ii) a signature that is not generated based on the first hash, and wherein the first unlocking script comprises either signature;
generating the solution to the cryptographic puzzle, wherein the solution is based on the message, and wherein the solution to the cryptographic puzzle requires knowledge of the first hash based on the message;
generating a first signature based on the first hash or a second signature that is not generated based on the first hash;
generating a response blockchain transaction, wherein generating the response blockchain transaction comprises:
generating a first input of the response blockchain transaction that includes a first unlocking script and a reference to the first output of the request transaction;
including the solution to the cryptographic puzzle in the first unlocking script;
including the first or second signature in the first unlocking script; and
causing the response blockchain transaction to be submitted to a blockchain network.

18. The method of claim 17, wherein the cryptographic puzzle is based on only a portion of the first message.

19. (canceled)

20. The method of claim 17, wherein the first unlocking script of the request transaction comprises a first value based on the first hash and a first private key, and wherein the solution comprises a signature generated using the first private key.

21. The method of claim 17, wherein the response blockchain transaction comprises a signature generated using a second private key, wherein the second private key is based on the first hash.

22-23. (canceled)

24. The method of claim 17, wherein the first hash is based on only a portion of the message.

25. (canceled)

26. The method of claim 17, wherein the message is received in an encrypted form.

27. The method of claim 26, wherein:
said encrypted form of the message is a result of encryption of the message using an identity-based encryption scheme, wherein said encryption is based on a public key associated with the second party, and wherein the method comprises decrypting the encrypted message using a private key corresponding to the public key.

28. (canceled)

29. A non-transitory computer readable medium comprising a computer program configured so as, when run on one or more processors, the one or more processors perform a method of requesting a read receipt for a message using a blockchain, the read receipt evidencing that the message has been opened, the method being performed by a first party and comprising:
sending the message, and/or an encrypted version thereof, to a second party:
generating a cryptographic puzzle based on the message, including generating a first hash based on the message by performing a cryptographic hashing operation on the message;
generating a request blockchain transaction, wherein generating the request blockchain transaction comprises:
generating a first output of the request blockchain transaction;
constructing a first locking script that is configured to, when executed together with a first unlocking script of a response blockchain transaction, require the first unlocking script to comprise a solution to the cryptographic puzzle,
wherein constructing the first locking script comprises constructing a conditional clause sub-script that is configured to require the first unlocking script of the response transaction to further comprise either i) a signature generated based on the first hash, or ii) a signature generating using a private key corresponding to a public key associated with the second party;
causing the request blockchain transaction to be submitted to a blockchain network;
determining that the first output of the request blockchain transaction has been unlocked; and
determining that the message has been opened in response to determining that the first output has been unlocked.
